(19) United States
(12) Patent Application Publication
(10) Pub. No.: US 2015/0263789 A1
(43) Pub. Date: Sep. 17, 2015

(54) CIRCUIT ARRANGEMENT

(71) Applicant: Infineon Technologies AG, Neubiberg (DE)

(72) Inventors: Martin Buchsbaum, Graz (AT); Josef Gruber, St. Ruprecht an der Raab (AT); Juergen Hoelzl, Graz (AT); Walter Kargl, Graz (AT); Peter Raggam, St. Stefan i. R. (AT)

(21) Appl. No.: 14/644,236

(22) Filed: Mar. 11, 2015

(30) Foreign Application Priority Data
Mar. 11, 2014 (DE) 102014103214.4

(51) Int. Cl. H04B 5/00; H04L 7/033; H04W 72/04; H04B 1/3816

(52) U.S. Cl. CPC H04B 5/0031; H04B 1/3816; H04L 7/0331; H04W 72/0453

(57) ABSTRACT

A circuit arrangement is provided, having an antenna, a first circuit coupled to the antenna and configured to receive an antenna signal, which contains first data, and to process the antenna signal, as a result of which it produces a processed antenna signal having a different voltage level than that of the antenna signal. The first data are data transmitted from a communication device to the arrangement. The arrangement further includes a second circuit coupled to the first circuit via a wire-based interface. The first circuit is configured to transmit the processed antenna signal to the second circuit by a first channel of the wire-based interface and the second circuit is configured to transmit second data to the first circuit by a second channel of the wire-based interface. The first channel and the second channel are different. The second data are configuration data for configuring the first circuit.

### CROSS-REFERENCE TO RELATED APPLICATION

This application claims priority to German Patent Application Serial No. 10 2014 103 214.4, which was filed Mar. 11, 2014, and is incorporated herein by reference in its entirety.

### TECHNICAL FIELD

Various embodiments relate generally to circuit arrangements.

### BACKGROUND

In a circuit arrangement for wireless communication, for example for NFC (near field communication) communication, received signals are typically amplified by a front end and forwarded to a processing circuit. For some instances of application, it may be desirable for there to be an option for the processing circuit to reconfigure the front end, for example to set it to a different communication type or a different bit rate. Accordingly, arrangements that allow the transmission of data from one circuit to another circuit, which amplifies received radio signals, are desirable.

### SUMMARY

A circuit arrangement is provided, having an antenna, a first circuit coupled to the antenna and configured to receive an antenna signal, which contains first data, and to process the antenna signal, as a result of which it produces a processed antenna signal having a different voltage level than that of the antenna signal. The first data are data transmitted from a communication device to the arrangement. The arrangement further includes a second circuit coupled to the first circuit via a wire-based interface. The first circuit is configured to transmit the processed antenna signal to the second circuit by a first channel of the wire-based interface and the second circuit is configured to transmit second data to the first circuit by a second channel of the wire-based interface. The first channel and the second channel are different. The second data are configuration data for configuring the first circuit.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various embodiments of the invention are described with reference to the following drawings, in which:

FIG. 1 shows a communication arrangement according to one embodiment;

FIG. 2 shows a circuit arrangement according to one embodiment;

FIG. 3 shows a communication arrangement;

FIG. 4 shows a signal diagram that illustrates the realization of the second communication channel by time-division multiplexing with coding infringement;

FIG. 5 shows a signal diagram that illustrates the realization of the second communication channel by time-division multiplexing by a special auxiliary carrier;

FIG. 6 shows a signal diagram that illustrates the realization of the second communication channel by amplitude modulation;

FIG. 7 shows a signal diagram that illustrates the realization of a bidirectional second communication channel by amplitude modulation; and

FIG. 8 shows a signal diagram that illustrates a further example of the realization of the second communication channel by time-division multiplexing.

### DESCRIPTION

The following detailed description refers to the accompanying drawings that show, by way of illustration, specific details and embodiments in which the invention may be practiced.

The word “exemplary” is used herein to mean “serving as an example, instance, or illustration”. Any embodiment or design described herein as “exemplary” is not necessarily to be construed as preferred or advantageous over other embodiments or designs.

The word “over” used with regards to a deposited material formed “over” a side or surface, may be used herein to mean that the deposited material may be formed “directly on”, e.g. in direct contact with, the implied side or surface. The word “over” used with regards to a deposited material formed “over” a side or surface, may be used herein to mean that the deposited material may be formed “indirectly on” the implied side or surface with one or more additional layers being arranged between the implied side or surface and the deposited material.

The detailed description that follows relates to the enclosed figures, which show details and embodiments. These embodiments are described in such detail for a person skilled in the art to be able to implement the invention. Other embodiments are also possible and the embodiments can be altered in structural, logical and electrical respects without departing from the subject matter of the invention. The various embodiments are not necessarily mutually exclusive, but rather it is possible for various embodiments to be combined with one another, so that new embodiments are produced.

For use in devices with a small form factor, it is possible to use a boosted NFC (near field communication) system that can be based on a SIM (subscriber identity module) card or a microSD card.

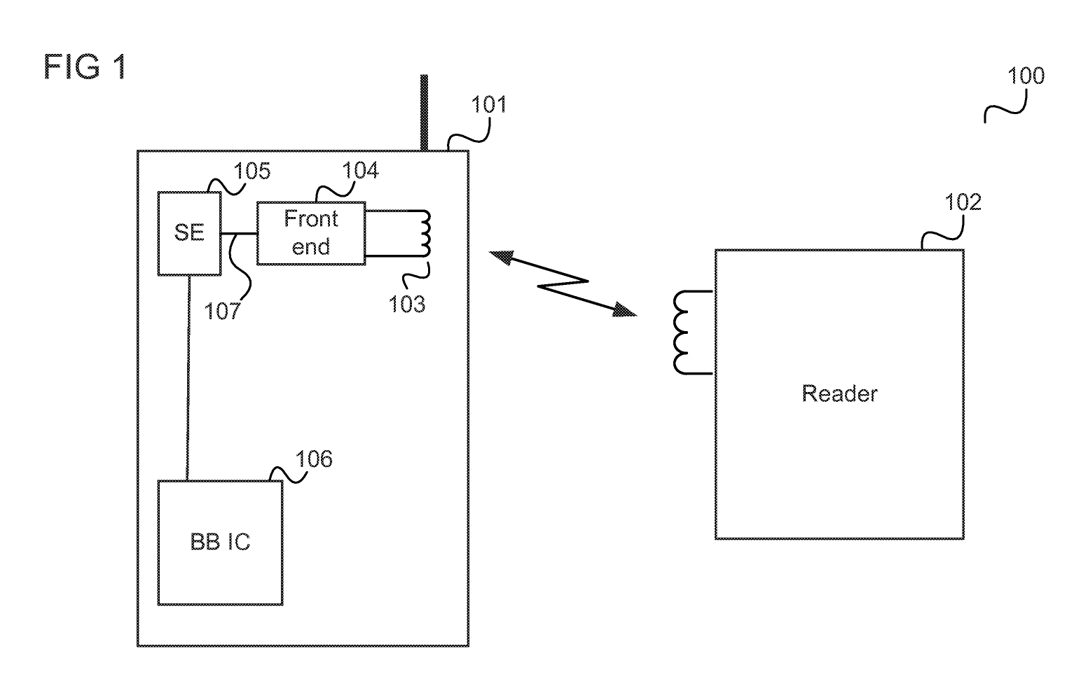

An example of an NFC system is shown in FIG. 1.

FIG. 1 shows a communication arrangement 100 according to one embodiment.

The communication arrangement 100 has a mobile telephone 101 and an (NFC) reader 102 (which is also referred to as a contactless reader).

The mobile telephone has an (NFC) antenna 103 that is coupled to a secure element or security element (SE) 105 via an (NFC) front end 104. The SE 105 is furthermore coupled to a baseband IC (integrated circuit) 106, for example based on ISO/IEC 7816.

The mobile telephone 101 can also have a SIM card that contains the SE 105, the front end 104 and the antenna 103.

A signal transmitted from the reader 102 to the mobile telephone 101, for example on the basis of ISO/IEC 14443, is amplified by the front end 103 and forwarded to the SE 105 via a wired interface 107 on the basis of the ISO/IEC 14443 protocol. By way of example, the interface 107 may be a DCLB (digital contactless bridge) interface or an ACLB (advanced contactless bridge) interface.

The SE 105 responds (for example following communication with the baseband IC 106) back to the front end, which amplifies the signal received from the SE 105 by means of active modulation using the battery voltage available in the mobile telephone and transmits said signal on the contactless interface between the mobile telephone 101 and the reader 102.

The front end 104 is typically preset to the communication type and the bit rate, e.g. type A 106 kbit/s or type B 106 kbit/s. In order to allow communication at a higher bit rate or using another type of communication, it is necessary for the secure element 105 to forward an appropriate piece of information to the front end. For this purpose, a special secure element having an SPI (serial peripheral interface) interface to the front end may be provided. However, this typically increases the system price substantially. Furthermore, such an SPI interface is not provided for certain secure elements.

According to one embodiment, an option is provided for transmitting configuration data from a secure element to a front end without an SPI interface, or generally information from one circuit to a further circuit, which amplifies an antenna signal and is connected to the circuit by a line-based interface.

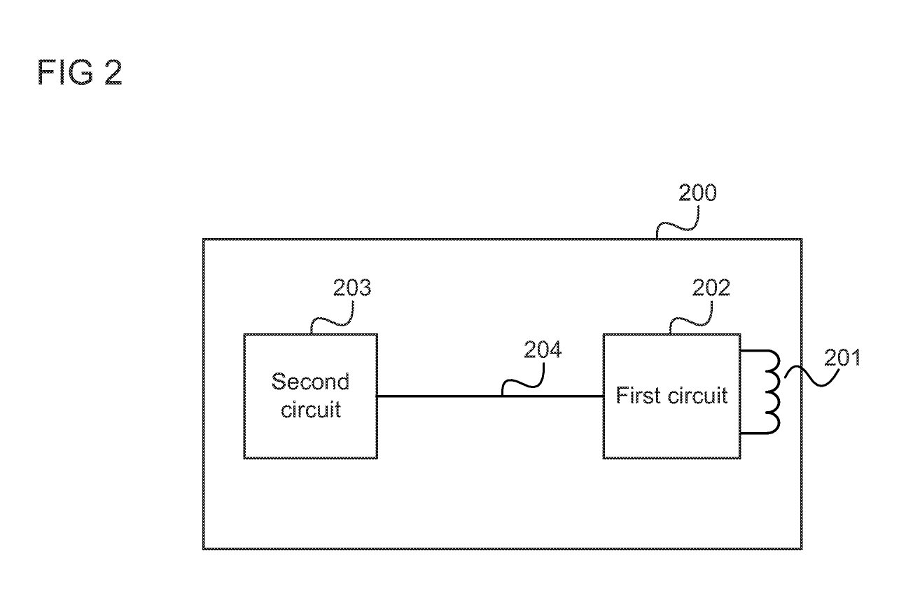

FIG. 2 shows a circuit arrangement 200 according to one embodiment.

The circuit arrangement 200 has an antenna 201 and a first circuit 202 that is coupled to the antenna 201 and is set up to receive an antenna signal, which contains first data, from the antenna 201 and to process the antenna signal, as a result of which it produces a processed antenna signal having a different voltage level than that of the antenna signal, wherein the first data are data transmitted from a communication device to the circuit arrangement.

The circuit arrangement 200 additionally has a second circuit 203 that is coupled to the first circuit 202 via a wire-based interface 204.

The first circuit 202 is set up to transmit the processed antenna signal to the second circuit 203 by a first communication channel of the wire-based interface 204. The second circuit 203 is set up to transmit second data to the first circuit 202 by a second communication channel of the wire-based interface, wherein the first communication channel and the second communication channel are different, wherein the second data are configuration data for configuring the first circuit.

In other words, two different communication channels are provided on a communication interface between two circuits, wherein the first communication channel is used for useful data transmission, i.e. of received data or data to be sent, for example, and the second, additional communication channel is used for communicating configuration data or control data, for example.

The second circuit may be set up to produce the second data, i.e. the configuration data for configuring the first circuit. The second circuit may be set up to transmit the second data via the second communication channel on the basis of data (e.g. the processed antenna signal) received from the first circuit via the first communication channel.

By way of example, the second circuit is set up to transmit third data to the first circuit by the first communication channel of the wire-based interface.

By way of example, the third data are data to be transmitted from the first circuit to a communication device by the antenna.

By way of example, the first communication channel and the second communication channel differ in an initial sequence used for a data transmission.

According to one embodiment, the first communication channel and the second communication channel differ in a carrier frequency used for a data transmission.

According to one embodiment, the first communication channel and the second communication channel differ in a pulse frequency used for a data transmission.

According to one embodiment, the first communication channel and the second communication channel differ in an amplitude used for a data transmission.

The second communication channel may be set up as a bidirectional communication channel.

By way of example, the first circuit is a radio transmission front end.

By way of example, the first circuit has a phase locked loop that is synchronized to the communication device.

By way of example, the other voltage level is a higher voltage level.

According to one embodiment, the second circuit is a secure element.

By way of example, the second circuit is an NFC security element.

The circuit arrangement may have a SIM card or a microSD card that contains the second circuit. The SIM card or the microSD card may also contain the antenna and/or the first circuit.

According to one embodiment, the first circuit is optionally set up to detect whether the first data are addressed to the circuit arrangement and is set up to transmit the first data to the second circuit if the first data are addressed to the circuit arrangement.

By way of example, the first circuit is set up for wireless communication based on ISO/IEC 14443 by means of the antenna.

According to one embodiment, the first circuit implements a portion of the logic required for wireless communication based on ISO/IEC 14443.

According to one embodiment, the interface implements a DCLB interface or an ACLB interface.

Various embodiments are described in more detail below.

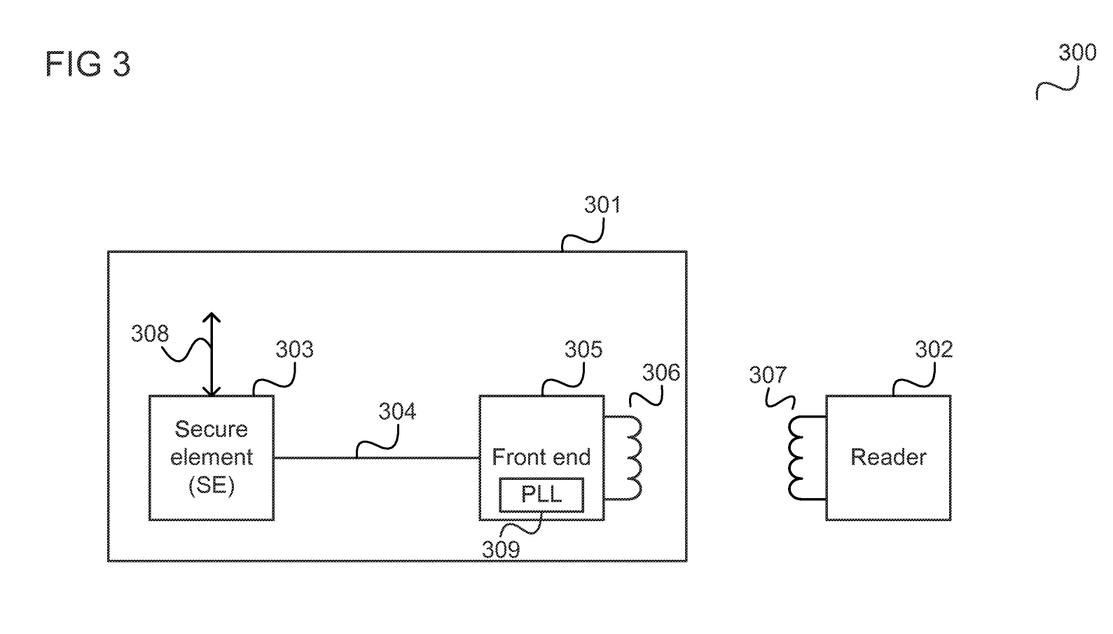

FIG. 3 shows a communication arrangement 300.

The communication arrangement 300 has a circuit arrangement 301 and a reader 302.

The circuit arrangement 301 has a secure element 303 that is coupled to a front end 305 via a wired interface 304.

The circuit arrangement 301 and the reader 302 each have an antenna 306, 307 and communicate wirelessly by the antennas 306, 307 on the basis of ISO/IEC 14443.

The secure element 303 and the front end 305 correspond to the SE 105 and the front end 104, for example. Accordingly, the secure element 303 has, by way of example, an interface 308 based on ISO/IEC 7816 to one or more further components (for example a baseband IC). By way of example, the front end 305 is an active front end and, by way of example, is supplied with power by a power supply, for example a battery in the mobile telephone 101. By way of example, the front end 305 has a PLL (phase locked loop) 309 that is synchronized to the reader 302, i.e. that is synchronized to the frequency used by the reader 302 for communicating with the mobile telephone 101.

According to one embodiment, data interchange, for example for system data such as bit rate and communication type, is implemented on the wired interface 304 without influencing the communication based on the standardized ISO/IEC 14443 communication protocol on the interface 304 (e.g. without disturbing the communication based on the ISO/IEC 14443 communication protocol). The contactless communication between the circuit arrangement 301 and the reader 302 is not disturbed by the data interchange.

According to one embodiment, a second communication channel in addition to the communication channel that is used to transmit the data received from the reader 302 or to be transmitted to the reader on the interface 304 is implemented on the interface 304 for this data interchange.

This second communication channel is used for data interchange in the following cases, for example:
Application configuration: An application that is executed on the circuit arrangement 301 (e.g. on a mobile telephone) wishes to reconfigure the front end 305, for example because the user selects a transport application for a particular country. By way of example, this requires the communication type to be changed over from type A to type B. By way of example, a product needs to be able to be used both in markets that require type A communication and in markets that require type B communication.
Runtime configuration: During contactless communication, the front end 305 needs to be reconfigured by the secure element 303, e.g. in order to change the bit rate to a higher bit rate (>106 kbit/s).
Initialization configuration: System data of the front end (e.g. configuration parameters) are stored in the secure element 303 and are transmitted to the front end 305 only when the system (i.e. the circuit arrangement) is started up. This can save implementation of a memory (e.g. an EEPROM) in the front end.

The additional data interchange, i.e. the data interchange of information, such as system data, via the interface in addition to the “normal” useful data interchange, i.e. the interchange of the data received from the reader 302 or to be transmitted to the reader 302, is effected on the basis of one of the following methods, for example:
time-division multiplexing with coding infringement, unidirectionally or bidirectionally
time-division multiplexing by a special auxiliary carrier, unidirectionally
simultaneous amplitude modulation (for amplitude modulation for useful data interchange), unidirectionally
simultaneous amplitude modulation (for amplitude modulation for useful data interchange), bidirectionally.

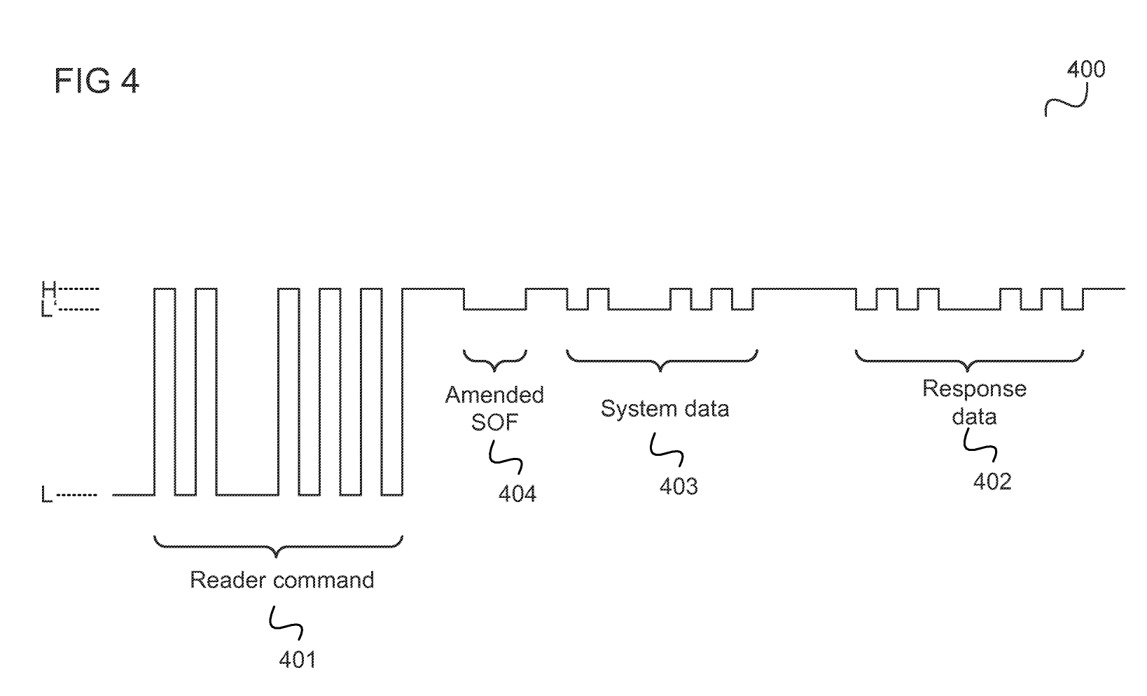

FIG. 4 shows a signal diagram 400 that illustrates the realization of the second communication channel by time-division multiplexing with coding infringement.

Time increases from left to right.

The signal diagram 400 first of all shows the transmission of a reader command 401, which the front end 305 has received from the reader 302, on to the secure element 303. In this case, the reader command 401 is coded such that pulses that reach a high level H (e.g. 3 volts) code a binary 1 and pulses that remain at the low level L (e.g. 0 volt) (that is to say in graphic terms absent pulses) code a binary 0, for example.

Data that are transmitted from the secure element 303 to the front end 305, in this example system data 403 and response data 402 (e.g. useful data in a response from the circuit arrangement to the reader command 401), are coded in this example such that pulses that reach the high level H from a third level L′ (e.g. 2.7 volts) code a binary 1 and pulses that remain at the third level L′ code a binary 0.

In this example, the transmission of system data 403, i.e. the transmission of data on the second communication channel, is characterized in that it is characterized by a special initial sequence SOF (for start of frame) 404, for example an initial sequence that infringes the ISO/IEC 14443 protocol. The front end 305 accordingly recognizes that the subsequent data are not response data 402 transmitted on the basis of the ISO/IEC 14443 protocol, but rather are system data 403.

The front end 305 does not transmit the system data 403 to the reader 302 on the contactless interface, as a result of which the transmission by the second communication channel is not seen externally, i.e. on the contactless interface.

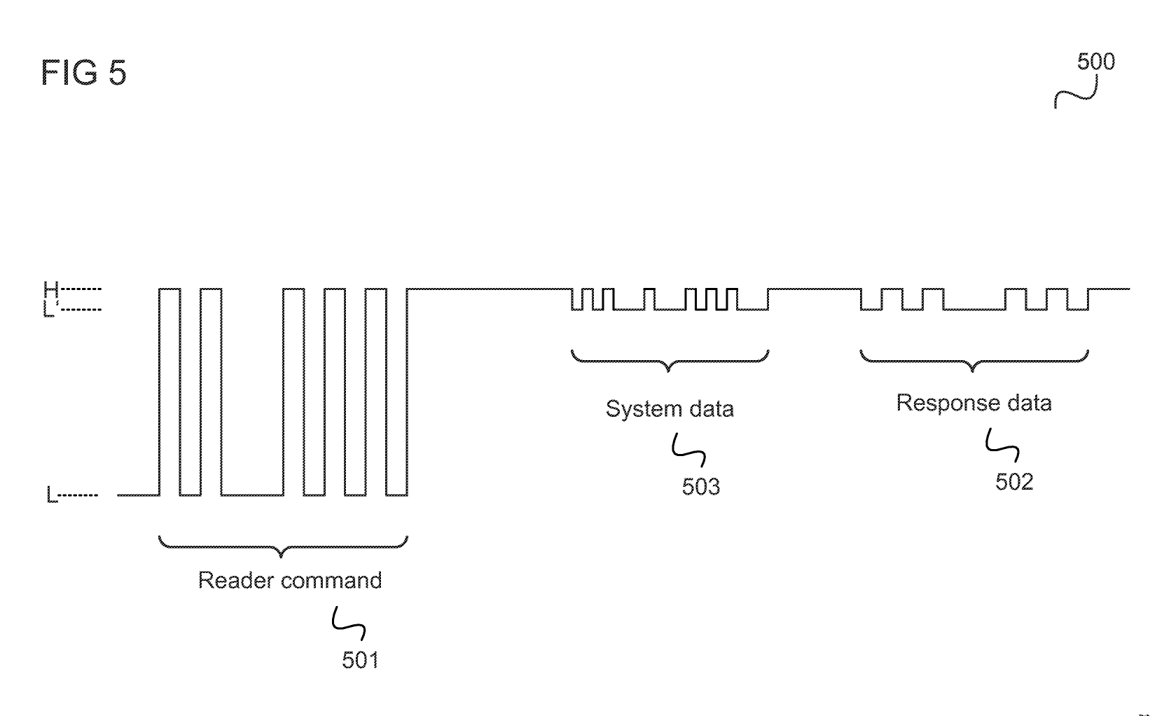

FIG. 5 shows a signal diagram 500 that illustrates the realization of the second communication channel by time-division multiplexing by a special auxiliary carrier.

The signal diagram 500 shows the transmission of a reader command 501, of system data 503 and of response data 502, wherein the reader command, the system data 503 and the response data 502 are transmitted using the levels H, L, L′, as explained above with reference to FIG. 4.

In contrast to FIG. 4, the system data transmission is indicated not by a special initial sequence but rather by virtue of the secure element sending the system data 503 using a second auxiliary carrier, i.e. the pulses that are used to transmit the system data 503 follow one another at a different frequency than the pulses that are used to transmit the response data 502, for example at double the frequency. The front end 305 accordingly recognizes the deviation in the pulse frequency and hence recognizes transmission of the system data 503.

The front end 305 does not transmit the system data 503 to the reader 302 on the contactless interface, as a result of which the transmission by the second communication channel is not seen externally, i.e. on the contactless interface.

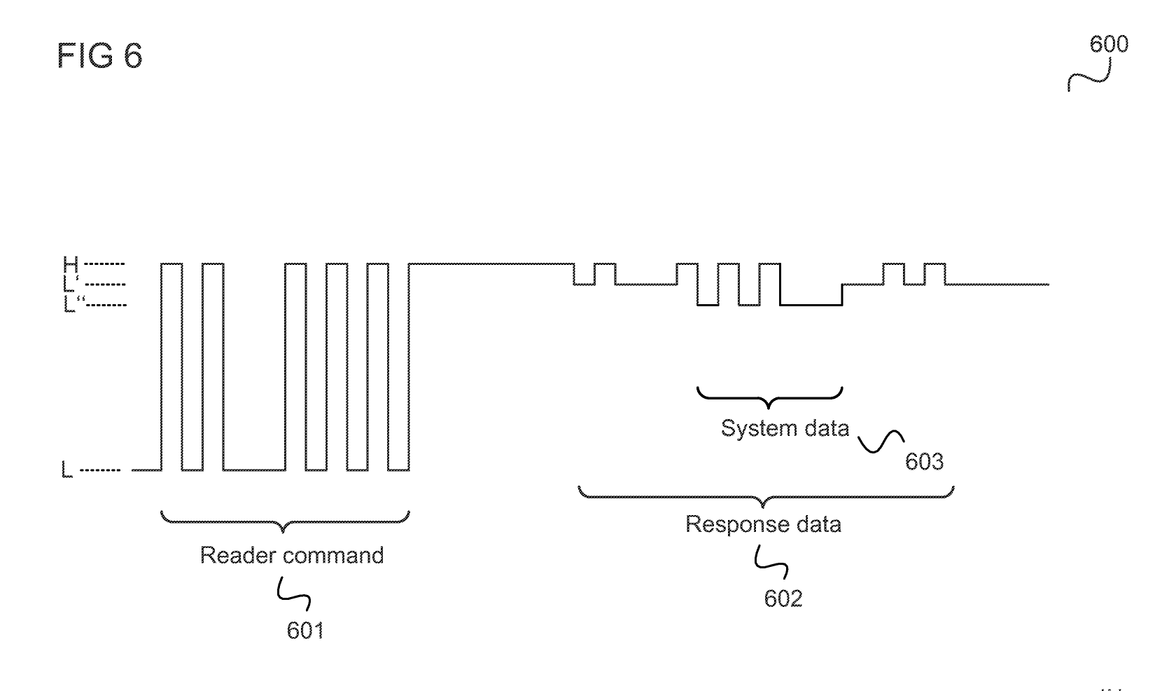

FIG. 6 shows a signal diagram 600 that illustrates the realization of the second communication channel by amplitude modulation.

The signal diagram 600 shows the transmission of a reader command 601, of system data 603 and of response data 602, wherein the reader command 601 and the response data 602 are transmitted using the levels H, L, L′, as explained above with reference to FIG. 4.

In contrast to FIG. 4 and FIG. 5, the system data transmission is indicated not by means of a special initial sequence or an altered pulse frequency but rather by the use of another amplitude for the pulses for transmitting the system data 602. Specifically, the system data 603 in this example are coded such that pulses that reach the high level H from a fourth level L″ (e.g. 2.4 volts) code a binary 1 and pulses that remain at the fourth level L″ code a binary 0.

The front end 305 can accordingly recognize that the level L′ is fallen short of (i.e. the level L″ is reached) and hence can recognize that system data 603 are being transmitted. If, by contrast, the level L′ is not fallen short of, the front end 305 recognizes that response data 602 are being transmitted. The levels L′, L″ can therefore be regarded as threshold values that the front end uses to recognize whether system data 603 or response data 602 are being transmitted.

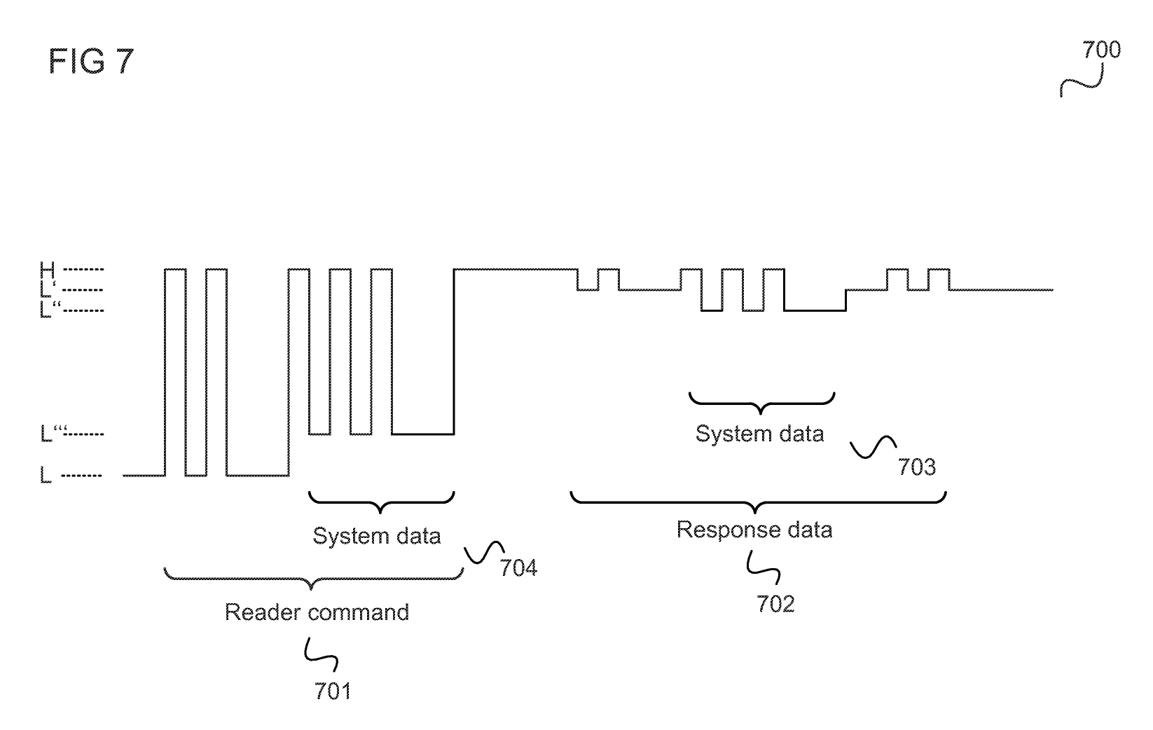

In graphic terms, the interface 304 is extended by an adaptive modulation index for transmitting system data 603 by transmitting the system data 603 by altering the modulation that is used by the secure element 303. This approach can also be used for transmitting system data from the front end 305 to the secure element 303, as shown in FIG. 7.

FIG. 7 shows a signal diagram 700 that illustrates the realization of a bidirectional second communication channel by amplitude modulation.

The signal diagram 700 shows the transmission of a reader command 701, of first system data 703 and of response data 702, wherein the reader command 701, the system data 703 (corresponding to the system data 603) and the response data 702 are transmitted using the levels H, L, L′, L″, as in the example explained with reference to FIG. 6.

In this example, second system data 704 are furthermore transmitted from the front end 305 to the secure element 303. The system data transmission from the front end 305 to the secure element 303 is indicated by the use of a different amplitude for the pulses for transmitting the system data 704 than for the reader command 701. Specifically, the system data 704 in this example are coded such that pulses that reach the high level H from a fifth level L″′ (e.g. 0.6 volt) code a binary 1 and pulses that remain at the level L″′ code a binary 0.

The secure element 303 can accordingly recognize that the level L″′ is not fallen short of (i.e. the level L is not reached) and can therefore recognize that system data 704 are being transmitted from the front end 305 to the secure element 303. If the level L″′ is fallen short of, on the other hand, then the secure element 303 recognizes that a reader command (or reader command data) 701 is/are being transmitted. The levels L, L″′ can therefore be regarded as threshold values that the secure element uses to recognize whether system data 704 or reader command data 701 are being transmitted.

In the examples described with reference to FIG. 6 and FIG. 7, various amplitudes (i.e. pulse levels) are graphically used for the two communication channels. If the amplitudes are chosen in a suitable manner, pulses from the first communication channel and from the second communication channel can also be superimposed and can still be associated with the communication channels, as a result of which it is possible for the communication by means of the first communication channel and the communication by the second communication channel to be carried out in parallel.

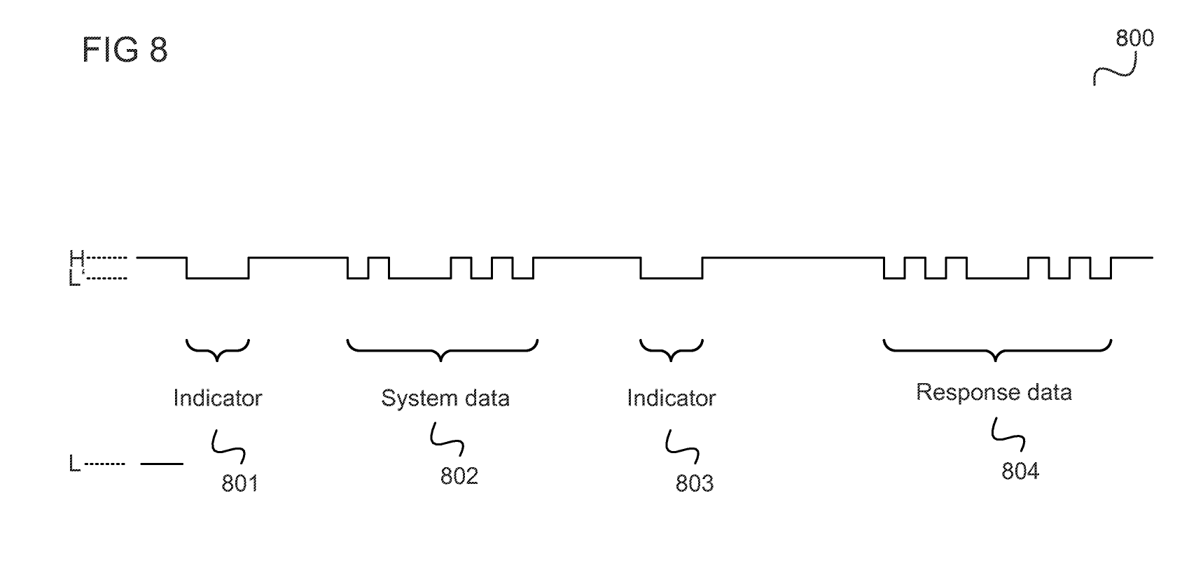

According to a further embodiment, an indicator is sent that indicates that configuration data are subsequently being sent. This is shown in FIG. 8.

FIG. 8 shows a signal diagram 800 that illustrates a further example of the realization of the second communication channel by time-division multiplexing.

Time increases from left to right.

In this example, a first indicator 801, which is transmitted from the secure element 303 to the front end 305, indicates to the front end 305 that a subsequent transmission is a transmission of system data 802. When the transmission of the system data 802 is at an end, or when a second indicator 803 is sent (which may have the same form as the first indicator), the front end 305 expects response data again, i.e. interprets received data as response data 804. In other words, the first indicator 801 and the second indicator 803 form an SOF (start of file) and an EOF (end of file) for the system data 802.

While the invention has been particularly shown and described with reference to specific embodiments, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A circuit arrangement. comprising:
an antenna;
a first circuit that is coupled to the antenna and is set up to receive an antenna signal, which contains first data, from the antenna and to process the antenna signal, as a result of which it produces a processed antenna signal having a different voltage level than that of the antenna signal, wherein the first data are data transmitted from a communication device to the circuit arrangement;
a second circuit that is coupled to the first circuit via a wire-based interface;
wherein the first circuit is set up to transmit the processed antenna signal to the second circuit by a first communication channel of the wire-based interface; and
wherein the second circuit is set up to transmit second data to the first circuit by a second communication channel of the wire-based interface, wherein the first communication channel and the second communication channel are different, wherein the second data are configuration data for configuring the first circuit.

2. The circuit arrangement as claimed in claim 1,
wherein the second circuit is set up to transmit third data to the first circuit by the first communication channel of the wire-based interface.

3. The circuit arrangement as claimed in claim 2,
wherein the third data are data to be transmitted from the first circuit to a communication device by the antenna.

4. The circuit arrangement as claimed in claim 1,
wherein the first communication channel and the second communication channel differ in an initial sequence used for a data transmission.

5. The circuit arrangement as claimed in claim 1,
wherein the first communication channel and the second communication channel differ in a carrier frequency used for a data transmission.

6. The circuit arrangement as claimed in claim 1,
wherein the first communication channel and the second communication channel differ in a pulse frequency used for a data transmission.

7. The circuit arrangement as claimed in claim 1,
wherein the first communication channel and the second communication channel differ in an amplitude used for a data transmission.

8. The circuit arrangement as claimed in claim 1,
wherein the second communication channel is set up as a bidirectional communication channel.

9. The circuit arrangement as claimed in claim 1,
wherein the first circuit is a radio transmission front end.

10. The circuit arrangement as claimed in claim 1,
wherein the first circuit has a phase locked loop that is synchronized to the communication device.

11. The circuit arrangement as claimed in claim 1,
wherein the other voltage level is a higher voltage level.

12. The circuit arrangement as claimed in claim 1,
wherein the second circuit is a secure element.

13. The circuit arrangement as claimed in claim 1,
wherein the second circuit is a near field communication security element.

14. The circuit arrangement as claimed in claim 1, further comprising:
a Subscriber Identity Module card or a microSD card that contains the second circuit.

15. The circuit arrangement as claimed in claim 1,
wherein the first circuit is set up to detect whether the first data are addressed to the circuit arrangement and is set up to transmit the first data to the second circuit if the first data are addressed to the circuit arrangement.

16. The circuit arrangement as claimed in claim 1,
wherein the first circuit is set up for wireless communication based on ISO/IEC 14443 by the antenna.

17. The circuit arrangement as claimed in claim 1,
wherein the first circuit implements a portion of the logic required for wireless communication based on ISO/IEC 14443.

18. The circuit arrangement as claimed in claim 1,
wherein the interface implements a digital contactless bridge interface or an advanced contactless bridge interface.
